(19) United States
(12) Patent Application Publication
(10) Pub. No.: US 2002/0053382 A1
(43) Pub. Date: May 9, 2002

(54) Pneumatic tire

(75) Inventors: Shinichi Mori, Hiratsuka-shi (JP); Masakuni Kawamura, Hiratsuka-shi (JP)

Correspondence Address: RADER FISHMAN & GRAUER PLLC, LION BUILDING, 1233 20TH STREET N.W., SUITE 501, WASHINGTON, DC, 20036, US

(73) Assignee: THE YOKOHAMA RUBBER CO., LTD.

(21) Appl. No.: 09/951,507

(22) Filed: Sep. 14, 2001

(30) Foreign Application Priority Data
Sep. 18, 2000 (JP) 2000-281253

(51) Int. Cl. B60C 11/00

(52) U.S. Cl. 152/209.9; 152/209.14

(57) ABSTRACT

Disclosed is a pneumatic tire capable of effectively making even a contact pressure of land portions composed of blocks or ribs. In the pneumatic tire, the plurality of land portions defined by grooves are provided on a tread, curved chamfered portions are formed on end peripheries of the land portions, a relation between a groove width A of the groove on a tread surface, the groove being adjacent to the end periphery, and a curvature radius B on the chamfered portion is established as: B=kA, and a value of a constant k is set in a range of 0.2 to 0.3.

### BACKGROUND OF THE INVENTION

The present invention relates to a pneumatic tire in which end peripheries of blocks or ribs are chamfered, more particularly to a pneumatic tire capable of effectively making even a contact pressure distribution of the blocks or the ribs.

In a pneumatic tire including separated blocks on a tread, high contact pressures are generated on leading edges and trailing edges of the blocks during rotation of the tire. As a result, in some cases, heel & toe wear is generated, or a frictional force at a contact portion is lowered, thus a grip force cannot be exerted sufficiently. In order to make even the contact pressure distribution of the blocks, it is effective to chamfer the end peripheries of the blocks. As prior arts for such chamfering, for example, Japanese patent application Kokai publication No. 2-179508 discloses a technology, in which the entire peripheries of blocks are chamfered to be planes. Japanese patent application Kokai publication No. 10-297219 discloses a technology, in which end peripheries of blocks are chamfered to be curved surfaces, and a curvature of such chamfered surface is changed in response to a distance from a center position of the block to the end periphery.

However, in the case where chamfered portions are formed on the end peripheries of the blocks based on the foregoing prior arts, when an interval between the blocks adjacent to each other is narrow, specifically when a groove width between the blocks is narrow, there has existed a problem that an effect of making even the contact pressure distribution owing to the chamfering cannot be sufficiently exerted. Namely, in the case where the interval between the adjacent blocks is narrow, contact pressures of the both blocks affect each other, therefore, there is a tendency that the contact pressure distribution is made even without forming such chamfered portions. Accordingly, if a size of each chamfered portion of the block is not determined in accordance with a relation thereof with the groove width, the contact pressure distribution of the block cannot be effectively made even. Hence, a sufficient performance of the tire cannot be exerted.

### SUMMARY OF THE INVENTION

The object of the present invention is to provide a pneumatic tire capable of effectively making even a contact pressure distribution of land portions composed of blocks or ribs.

In order to achieve the foregoing object, according to the present invention, there is provided a pneumatic tire, including: a plurality of land portions defined by grooves on a tread, wherein a curved chamfered portion is formed on an end periphery of each of the plurality of land portions, a relation between a groove width A of a groove on a tread surface, the groove being adjacent to the end periphery, and a curvature radius B of the chamfered portion is established as: B=kA, and a value of a constant k is set in a range of 0.2 to 0.3.

As described above, the groove width A of the groove on the tread surface, the groove being adjacent to the end periphery of the land portion, and the curvature radius B of the chamfered portion are allowed to have the foregoing relation, and the narrower the groove width A is, the smaller the curvature radius B of the chamfered portion is made. Thus, the contact pressure distribution of the land portions composed of the blocks or the ribs can be effectively made even. Consequently, a driving stability or a braking ability of the pneumatic tire can be improved.

The chamfered portion does not always have to be formed on all the end peripheries of the land portions. For example, in the case where the chamfered portions are formed along a main groove extending in a tire circumference direction, the contact pressure distribution is made even in a tire width direction, thus the driving stability is improved. Moreover, in the case where the chamfered portions are formed along a lateral groove extending in the tire width direction, the contact pressure distribution is made even in a tire circumference direction, thus the braking ability is improved. As a matter of course, when the chamfered portions are formed on all the end peripheries of the land portions, the driving stability and the braking ability can be improved simultaneously, which is the most preferable.

The present invention is particularly suitable for a wet racing tire, and can exert an excellent driving stability for such use. Namely, in a racing tire with a tread design in which the groove width is somewhat wide, a phenomenon called a buckling in which the tread is bent during contact at a groove bottom taken as an inflection point is generated due to a large load applied thereto. In this case, the curved chamfered portions are provided to the edges of each block as described above, thus a road surface and the edges contact each other by relatively wide surfaces. Therefore, the effect of improving the driving stability is particularly obtained.

### BRIEF DESCRIPTION OF THE DRAWINGS

FIG. 1 is a development view showing a tread pattern of a pneumatic tire according to an embodiment of the present invention.

FIG. 2 is a sectional view taken along a line X-X of FIG. 1.

FIG. 3 is a sectional view taken along a line Y-Y of FIG. 1.

FIG. 4 is a sectional view taken along a line Z-Z of FIG. 1.

### DETAILED DESCRIPTION OF THE PREFERRED EMBODIMENT

Hereinbelow, description will be made for a constitution of the present invention with reference to the accompanying drawings.

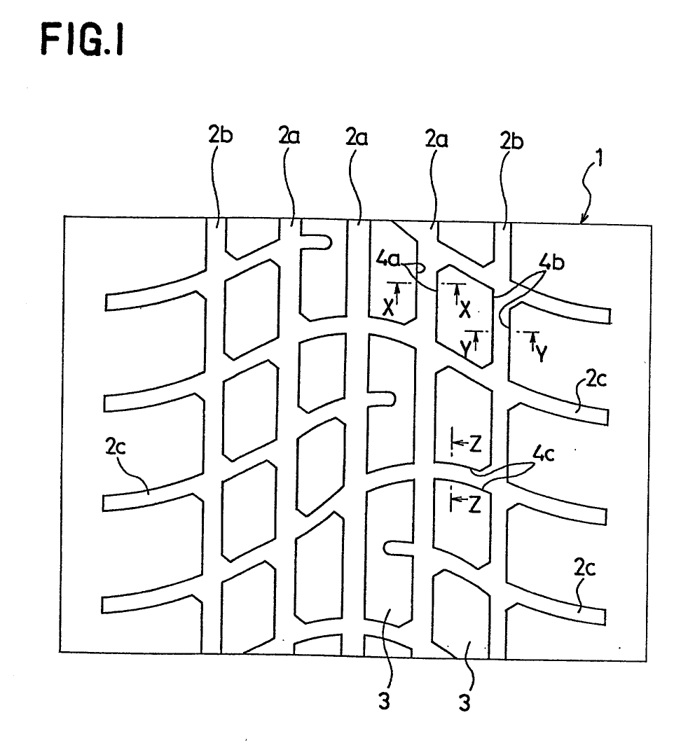

FIG. 1 is a view exemplifying a tread pattern of a pneumatic tire according to an embodiment of the present invention. In FIG. 1, two types of main grooves 2a and 2b extending in a tire circumference direction and lateral grooves 2c extending in a tire width direction are provided on a tread 1. A plurality of blocks 3 are defined by the main grooves 2a and 2b and the lateral grooves 2c. The three main grooves 2a arranged at a center portion of the tread 1 have a groove width slightly wider than that of the two main grooves 2b arranged at shoulder sides of the tread 1. Moreover, the main grooves 2b have a groove width slightly wider than that of the lateral grooves 2c.

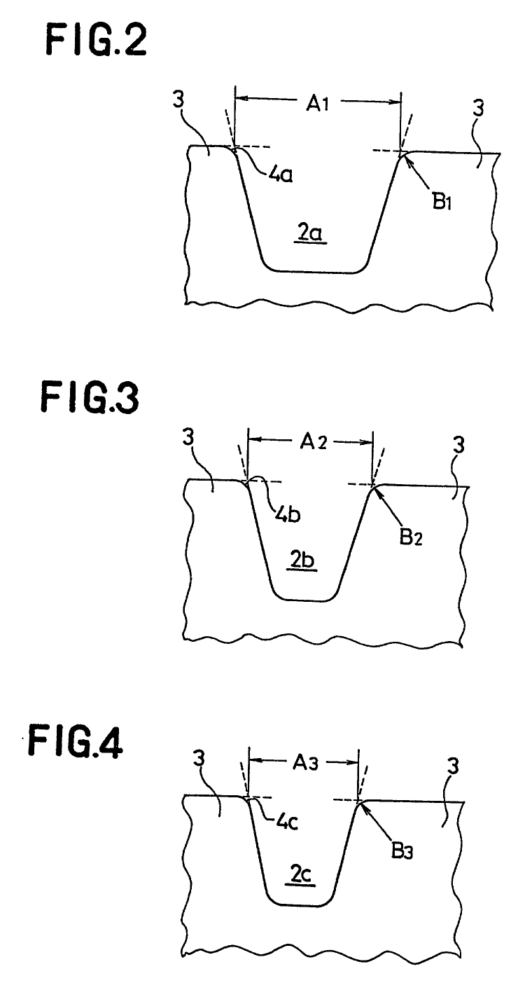

In the pneumatic tire described above, on end peripheries of the blocks 3, chamfered portions 4a to 4c, each having a circular arc section, are formed as shown in FIGS. 2 to 4. Each circular arc of the chamfered portions 4a to 4c is provided so as to be tangent to a tread surface and a groove wall surface. Each of such curved chamfered portions 4a to 4c has an effect of making even a contact pressure distribution, the effect being larger than that of a chamfered portion cut into a plane.

Here, when a groove width of a groove on the tread surface, the groove being adjacent to an end periphery of the block 3, is set as A (A₁ to A₃), and a curvature radius of the chamfered portion at the end periphery of the block 3 is set as B (B₁ to B₃), the curvature radius B is regulated by the following general equation (1).

B=kA (1),

where k is an arbitrary constant selected from a range of 0.2≦k≦0.3.

When an intersection point of extensions of the tread surface and the groove wall surface is obtained as shown in the drawings, the groove width A (mm) of the groove on the tread surface corresponds to a distance between the intersection points. Meanwhile, the curvature radius B (mm) of the chamfered portion is a curvature radius measured when the tread is cut on a surface perpendicular to the grooves.

As shown in FIGS. 2 to 4, a groove width A₁ of the main groove 2a, a groove width A₂ of the main groove 2b and a groove width A₃ of the lateral groove 2c are different from one to another. Therefore, a curvature radius B₁ of each of the chamfered portions 4a formed on both sides of the main groove 2a, a curvature radius B₂ of each of the chamfered portions 4b formed on both sides of the main groove 2b and a curvature radius B₃ of each of the chamfered portions 4c formed on both sides of the main groove 2c are set to be different from one to another in accordance with the above equation (1). As a matter of course, for the grooves having the same groove width, the same curvature radius can be set.

As described above, the curvature radii B₁ to B₃ of the chamfered portions 4a to 4c are set so as to correspond to the groove widths A₁ to A₃ of the grooves 2a to 2c on the tread surface. Thus, the contact pressure distribution of the block 3 is effectively made even, and hence the driving stability and the braking ability of the pneumatic tire can be improved more than a conventional pneumatic tire. Moreover, occurrence of uneven wear is suppressed by making even the contact pressure distribution.

In the present invention, when the value of the constant k is less than 0.2, since the edge of the block is too sharp, a tire performance in this case is hardly different from a tire without any chamfered portion. Meanwhile, when the value of the constant k exceeds 0.3, since an actual contact area is reduced, there occurs a lack of a grip force.

The present invention is also advantageous in that a process cost for the chamfered portion can be suppressed. Specifically, in accordance with a conventional method in which a curvature in chamfering the end periphery to be curved surface is changed in response to a distance from a center position of a block to the end periphery thereof, though a somewhat effect can be expected, a process cost for a die is increased to a great extent since a shape of the chamfered portion is changed along the groove. Conversely, in the present invention, since the curvature radius of the chamfered portion is constant along the groove, the process cost for the die can be suppressed to be low.

In the above embodiment, description has been made for the tread pattern mainly composed of blocks. However, in the present invention, also in the case where ribs having chamfered portions are provided on the tread, a similar operational effect is obtained by determining a relation between a groove width of a groove on the tread surface, the groove being adjacent to an end periphery of the rib on the tread surface, and a curvature radius of the chamfered portion.

### EXAMPLES

With regard to pneumatic tires, in which a front tire size is set at 200/50 VR13 and a rear tire size is set at 240/45 VR13, each tire having the tread pattern of FIG. 1, there were prepared a conventional example, comparative examples 1 and 2, and examples 1 to 4, among which only the chamfered portions were varied. The conventional example is tires without the chamfered portions. The comparative examples 1 and 2 are tires, in which curved chamfered portions are formed on all the end peripheries of the blocks, and the curvature radius B of each chamfered portion is made to have the relation of B=kA with the groove width A, but the constant k is set to be out of a predetermined range. The examples 1 to 3 are tires, in which the curved chamfered portions are formed on all the end peripheries of the blocks, the curvature radius B of each chamfered portion is made to have the relation of B=kA with the groove width A, and the constant k is set to be within the predetermined range. The example 4 is tires, in which the curved chamfered portions are formed only on front and rear end peripheries of the blocks in the tire circumference direction, the curvature radius B of each chamfered portion is made to have the relation of: B=kA with the groove width A, and the constant k is set to be within the predetermined range.

These test tires were mounted on front and rear wheels of a racing car, an air pressure thereof was set at 100 kPa, then a feeling evaluation by a test driver was performed on a circle road including a curved road under wet and dry conditions. As evaluation items, there were employed a drivability as a criterion as to whether or not a vehicle moved rapidly when a steering wheel was turned, a stability as a criterion as to whether or not the vehicle was stable when a steering wheel was turned, and a braking ability as a criterion as to whether or not the vehicle was rapidly braked when a brake was operated. Table 1 shows evaluation results of the above, each of which is indexed with the conventional example set as 100. The larger the indices are, the more excellent the respective performances are.

TABLE 1

| | | | | Braking |
|---|---|---|---|---|
| | Constant k | Drivability | Stability | ability |
| Conventional | — | 100 | 100 | 100 |
| example | | | | |
| Comparative | 0.10 | 100 | 100 | 100 |
| example 1 | | | | |
| Comparative | 0.40 | 105 | 98 | 97 |
| example 2 | | | | |
| Example 1 | 0.20 | 108 | 104 | 105 |
| Example 2 | 0.25 | 112 | 107 | 108 |
| Example 3 | 0.30 | 109 | 102 | 103 |
| Example 4 | 0.25 | 108 | 100 | 106 |

As understood from Table 1, any tires of the examples 1 to 3 were good in drivability, stability and braking ability. The tires of the example 4 were good at least in braking ability. Meanwhile, in the tires of the comparative example 1, since the chamfered portions were too small, the effect of improving the tire performances was not observed. Moreover, in the tires of the comparative example 2, since the chamfered portions were too large, the stability and the braking ability were deteriorated.

According to the present invention, the relation between the groove width A of the groove on the tread surface, the groove being adjacent to the end peripheries of land portions, and the curvature radius B of the chamfered portion is established as: B=kA, and the value of the constant k is set in the range of 0.2 to 0.3. Thus, the contact pressure distribution of the land portions composed of the blocks or the ribs can be effectively made even, and the driving stability and the braking ability can be improved.

Although description has been made above for the preferred embodiment of the present invention, it should be understood that various modifications, alterations and substitutions can be performed therefor without departing from the spirit and the scope of the present invention defined by the appended claims.

What is claimed is:

1. A pneumatic tire, comprising:
a plurality of land portions defined by grooves on a tread,
wherein a curved chamfered portion is formed on an end periphery of each of said plurality of land portions, a relation between a groove width A of the each groove on a tread surface, the groove being adjacent to the end periphery, and a curvature radius B of the chamfered portion is established as: B=kA, and a value of a constant k is set in a range of 0.2 to 0.3.

2. The pneumatic tire according to claim 1, wherein the chamfered portion is formed along a main groove extending in a tire circumference direction.

3. The pneumatic tire according to claim 1, wherein the chamfered portion is formed along a lateral groove extending in a tire width direction.

4. The pneumatic tire according to claim 1, wherein the chamfered portion is formed on each end periphery of each of said plurality of land portions.

5. The pneumatic tire according to any one of claims 1 to 4, wherein said plurality of land portions are a plurality of blocks.

6. The pneumatic tire according to any one of claims 1 to 4, wherein the pneumatic tire is a racing tire mainly for use in competition.
